(19) United States
(12) Patent Application Publication
(10) Pub. No.: US 2025/0236564 A1
(43) Pub. Date: Jul. 24, 2025

(54) THERMALLY STABLE AEROGELS AND AEROGEL COMPOSITES

(71) Applicants: The Board of Trustees of the University of Illinois, Urbana, IL (US); U.S.A., as represented by the Administrator of the National Aeronautics and Space Administration, Washington, DC (US)

(72) Inventors: Nathaniel S. Olson, Pearland, TX (US); Jessica A. Krogstad, Champaign, IL (US); Frances I. Hurwitz, Shaker Heights, OH (US); Haiquan Guo, Avon, OH (US); Jamesa L. Stokes, Lakewood, OH (US)

(21) Appl. No.: 19/034,161

(22) Filed: Jan. 22, 2025

Related U.S. Application Data
(60) Provisional application No. 63/624,374, filed on Jan. 24, 2024.

(51) Int. Cl. C04B 35/80; C04B 35/624; C04B 35/626; C04B 35/628; C04B 38/00

(52) U.S. Cl. CPC C04B 35/80; C04B 35/624; C04B 35/62655; C04B 35/62807; C04B 35/62855; C04B 35/62897; C04B 38/0045; C04B 38/0054; C04B 2235/3225; C04B 2235/3246; C04B 2235/3418; C04B 2235/483; C04B 2235/5224; C04B 2235/5228; C04B 2235/606; C04B 2235/9607; C04B 2235/963

(57) ABSTRACT

A metal oxide-coated aerogel has an aerogel structure comprising yttria-stabilized zirconia (YSZ) and a coating on the aerogel structure. The YSZ includes at least about 20 mol. % yttria (YO_{1.5}) in zirconia (ZrO₂) and the coating comprises a metal oxide selected from the group consisting of silica, alumina, zirconia, and titania. An aerogel composite includes a fibrous material and an aerogel on surfaces and within interstices of the fibrous material, where the aerogel has an aerogel structure comprising yttria-stabilized zirconia (YSZ) and a coating on the aerogel structure that comprises a metal oxide. A method of forming a thermally stable aerogel comprises: forming a gel comprising yttria-stabilized zirconia (YSZ) including at least about 20 mol. % yttria (YO_{1.5}) in zirconia (ZrO₂); immersing the gel in a coating solution comprising a metal alkoxide and ethanol; and after the immersion, supercritically drying the gel, thereby forming a metal oxide-coated aerogel.

### RELATED APPLICATION

The present patent document claims the benefit of priority under 35 U.S.C. 119(e) to U.S. Provisional Patent Application No. 63/624,374, which was filed on Jan. 24, 2024, and is hereby incorporated by reference in its entirety.

### FEDERALLY FUNDED RESEARCH AND DEVELOPMENT

This invention was made with government support under 80NSSC18K1189 awarded by the National Aeronautics and Space Administration. The government has certain rights in the invention.

### TECHNICAL FIELD

The present disclosure is related generally to aerogels and more particularly to coated aerogels exhibiting enhanced thermal stability.

### BACKGROUND

A key challenge in aerospace is the development of lightweight insulation to replace dense ceramics for use in extreme environments. Aerogels are highly porous materials, with randomly cross-linked chains which form air-filled pores, creating solid structures that may be up to 99% air. Due to the high porosity, aerogels are extremely lightweight (densities can be under 0.05 g/cm³) and display extraordinarily low thermal conductivity (as low as 0.009 W/(m·K) in atmosphere and 0.003 W/(m·K) under vacuum). The low density of the solid network creates a tortuous path for solid conduction and provides very little cross-sectional area for heat to transfer through. The small pore sizes are smaller than the mean free path of gas molecules, preventing heat transfer via convection. Aerogels therefore present an excellent platform for lightweight, highly insulating materials. The engineering challenge aerogels face is collapse of the pore structure and loss of favorable properties upon exposure to high temperatures. The extremely high specific surface areas of the material drive densification and loss of surface area upon heating beyond 600° C. for most compositions. Upon surface area elimination and collapse of porosity, the thermal conductivity increases, density increases, and cracking occurs. This behavior compromises the performance of insulation utilizing aerogels at temperatures beyond temperatures of 600 to 1000° C. It would be advantageous to improve the upper temperature limit for use of aerogels as effective insulation.

### SUMMARY

Described in this disclosure is a thermally stable aerogel, an aerogel composite and a method of forming a thermally stable aerogel.

The thermally stable aerogel has an aerogel structure comprising yttria-stabilized zirconia (YSZ) and a coating on the aerogel structure. The YSZ includes at least about 20 mol. % yttria (YO_{1.5}) in zirconia (ZrO₂) and the coating comprises a metal oxide selected from the group consisting of silica, alumina, zirconia, and titania.

The aerogel composite comprises a fibrous material and an aerogel on surfaces and within interstices of the fibrous material, where the aerogel has an aerogel structure comprising yttria-stabilized zirconia (YSZ) and a coating on the aerogel structure that comprises a metal oxide.

A method of forming a thermally stable aerogel comprises: forming a gel comprising yttria-stabilized zirconia (YSZ) including at least about 20 mol. % yttria (YO_{1.5}) in zirconia (ZrO₂); immersing the gel in a coating solution comprising a metal alkoxide and ethanol; and after the immersion, supercritically drying the gel, thereby forming a metal oxide-coated aerogel.

### BRIEF DESCRIPTION OF THE DRAWINGS

FIG. 1 is a schematic illustration of a thermally stable metal oxide-coated aerogel.

FIGS. 2A and 2B show an aerogel composite in the form of a flexible sheet.

FIGS. 3A-3C show measurements of Brunauer-Emmett-Teller (BET) specific surface area (SSA), desorption cumulative pore volume, and desorption average pore size, respectively, for aerogels as a function of temperature, where the dark solid lines are data for uncoated aerogel structures and the light dashed lines are data for coated aerogel structures.

FIGS. 4A-4F show pore size distributions for (A) 0YSZ, (B) SiO₂-0YSZ, (C) 10YSZ, (D) SiO₂-10YSZ, (E) 30YSZ, and (F) SiO₂-30YSZ.

FIG. 5 shows scanning electron microscopy (SEM) images of uncoated and coated 0YSZ, 10YSZ, and 30YSZ, aerogels as-dried, after 600° C., after 1000° C., and after 1200° C. The scale bar in all images is 500 nm.

FIGS. 6A and 6B show bright field transmission electron microscopy (TEM) comparison of SiO₂-30YSZ at (A) 1000° C. and (B) 1200° C.; from 1000° C. to 1200° C., significant particle growth and densification are observed.

FIGS. 7A-7C show x-ray diffraction (XRD) scans of heat-treated aerogels (A) 0YSZ, (B) 10YSZ, and (C) 30YSZ.

FIGS. 8A-8C show x-ray diffraction (XRD) scans of heat-treated aerogels (A) SiO₂-0YSZ, (B) SiO₂-10YSZ, and (C) SiO₂-30YSZ.

FIG. 9 shows a bright field transmission electron microscopy micrograph of SiO2-30YSZ heat treated at 1200° C.

FIG. 10 shows normalized crystallite sizes of uncoated (darker bars) and coated (lighter bars) 0YSZ, 10YSZ, and 30YSZ aerogels after heat treatment. The sizes, D, are normalized by the dimensionless shape factor, C.

FIG. 11 shows x-ray diffraction (XRD) of heat-treated SiO₂-30YSZ aerogels with reference markers for the cubic phase (•, fluorite) and α-cristobalite phase (▪).

### DETAILED DESCRIPTION

The technology described in this disclosure pushes the envelope of performance for yttria-stabilized zirconia (YSZ) aerogels. A method of post-synthetic modification of YSZ gels with metal oxide coatings prior to processing via supercritical drying has been developed. The deposition of metal oxide coatings increases the robustness of the final coated aerogel and limits densification, crystallite growth, and loss of porosity to temperatures up to 1000° C., as shown in examples below utilizing silica coatings. Thermal stability to temperatures up to 1200° C. is expected for YSZ aerogels coated with alumina, titania, and/or zirconia.

The coated YSZ aerogels may be incorporated into insulation products to further reduce thermal conductivity and improve insulative performance. Applications for thermally stable YSZ aerogels include anywhere insulation is employed at elevated temperatures. Direct application to the development of thermal barrier seals is anticipated with direct use in space missions (e.g., space capsules, rovers) and in aircraft. The technology may also offer benefits in fire blankets and other applications where thermal management is required. The coated YSZ aerogels may be part of a composite including the coated YSZ aerogel and a fibrous material, as described below.

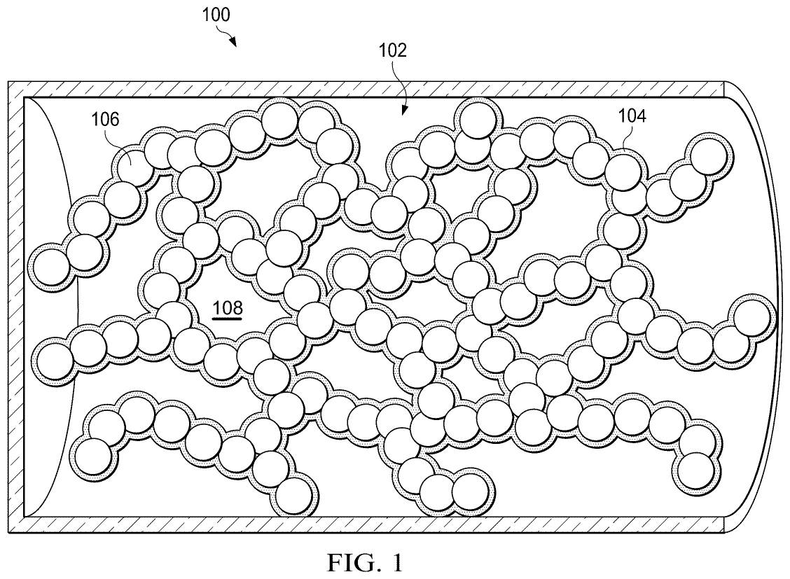

Referring to FIG. 1, the thermally stable aerogel 100 includes an aerogel structure 102 comprising yttria-stabilized zirconia (YSZ) and a coating 104 on the aerogel structure 102. Yttria-stabilized zirconia or YSZ may be understood to refer to zirconia chemically doped with yttria. The aerogel structure 102 may comprise a porous network of particles 106, where the particles 106 form branches or clusters that are separated by pores 108. The coating 104 is understood to coat exposed surfaces of the aerogel structure 102. The coating 104 comprises a metal oxide selected from the group consisting of silica, alumina, zirconia, and titania, and the YSZ includes at least about 20 mol. % yttria (YO_{1.5}) in zirconia (ZrO₂). In some examples, the YSZ may include at least about 30 mol. % yttria (YO_{1.5}), and/or up to about 50 mol. % yttria (YO_{1.5}). Previous investigations have shown that doping of zirconia aerogels with yttria may significantly improve the thermal stability. The present work establishes the importance of the metal oxide coatings on further enhancing thermal stability. As shown below, the application of metal oxide coatings to YSZ aerogel structures may reduce the influence of composition on thermal stability.

The as-produced metal oxide-coated aerogels 100 are highly porous with low densities and high surface areas, and these characteristics may be retained at elevated temperatures. The thermal stability can be evaluated in terms of the stability of the specific surface area and/or pore volume of the metal oxide-coated aerogel 100 at elevated temperatures (e.g., 600° C. or higher). Experiments described below reveal that the thermally stable aerogel 100 may exhibit a specific surface area (SSA) of at least about 350 m²/g at 600° C. and/or at least about 180 m²/g at 1000° C., determined according to the Brunauer-Emmett-Teller (BET) method. Also or alternatively, the thermally stable aerogel 100 may have a cumulative pore volume of at least about 1.8 cm³/g at 600° C. and/or at least about 1.2 cm³/g at 1000° C., determined via the Barrett-Joyner-Halenda (BJH) desorption method. The YSZ may remain amorphous up to 1000° C., as determined by x-ray diffraction.

The metal oxide coating 104 preferably has a thickness less than an average size of pores 108 of the aerogel structure 102. Typically, the aerogel structure 102 includes pores 108 in a range from 20 nm to 50 nm in average size. The thickness of the coating 104 may lie in the range from 1 nm to 10 nm.

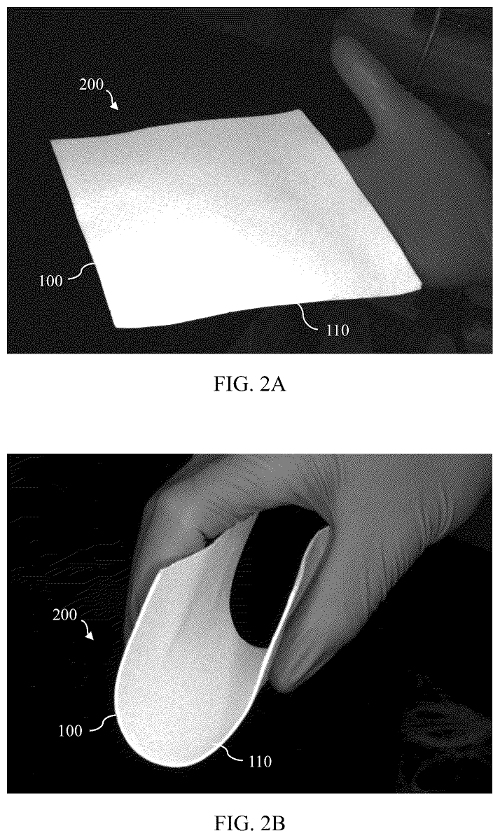

An aerogel composite may include the coated aerogel and a fibrous material for potential application in insulation and/or thermal management systems. More specifically, the aerogel composite 200, an example of which is shown in FIGS. 2A and 2B, may include a fibrous material 110 and the thermally stable aerogel 100 on surfaces and within interstices of the fibrous material. As described above, the aerogel 100 includes an aerogel structure 102 comprising yttria-stabilized zirconia (YSZ) and a coating 104 on the aerogel structure 102, where the coating 104 comprises a metal oxide, where the metal oxide may comprise silica, alumina, zirconia, and/or titania. The aerogel 100 employed for the composite 200 may have any or all of the features or characteristics described above or elsewhere in this disclosure. The fibrous material 110 may comprise a woven or non-woven fibrous material, where the latter may take the form of a felt or paper, for example. The woven or non-woven fibrous material may include natural or synthetic fibers, such as alumina, aluminosilicate, or aluminoborosilicate fibers. The aerogel composite 200 may take the form of a flexible sheet, as shown in FIGS. 2A and 2B. Inorganic aerogels such as the metal-oxide coated aerogel structures described in this disclosure may be somewhat fragile but can be strengthened with addition of woven or non-woven fibrous materials. The thermally stable aerogels may bond to the fibers and avoid spalling. The aerogel/fiber bond may be achieved by heat treatment of the fibrous materials to remove all binders prior to sol impregnation, as discussed below.

An insulation product used in elevated temperature environments (e.g., 600 to 1000° C., or higher) may include the thermally stable aerogel 100 and/or the aerogel composite 200.

Methods of forming the thermally stable aerogel 100 and the aerogel composite 200 are also described in this disclosure. A method of forming the thermally stable aerogel includes forming a gel comprising yttria-stabilized zirconia (YSZ) including at least about 20 mol. % yttria (YO_{1.5}) in zirconia (ZrO₂). Sol-gel methods known in the art may be employed to form the YSZ gel. In one example, gel precursors such as zirconyl chloride octahydrate and yttrium trichloride hexahydrate may be mixed in a solvent and hydrolyzed, followed by gelation.

The YSZ gel is then immersed in a coating solution comprising a metal alkoxide and ethanol. The metal alkoxide is selected based on the metal oxide coating to be formed on the aerogel structure. For example, the metal alkoxide may comprise tetraethyl orthosilicate (to form silica), aluminum-tri-sec-butoxide (to form alumina), zirconium(IV) butoxide (to form zirconia), and/or titanium(IV) isopropoxide (to form titania). The coating solution may further include nitric acid and water. In an example described below, gels to be coated with silica were immersed in a coating solution of tetraethyl orthosilicate (TEOS or Si(OC₂H₅)₄), deionized (DI) water, and nitric acid (HNO₃) in ethanol. The molar ratio of the metal alkoxide:ethanol:water:nitric acid in the coating solution may range from 0.5-1.5:7.0-8.4:0-2: 0-0.03. In some examples, the coating solution may consist of the metal alkoxide and the ethanol, that is, may include only the metal alkoxide and the ethanol. Typically, the coating solution includes the metal alkoxide at a concentration of 20-30 vol. %, or 25 vol. %. The coating solutions may be stirred for up to 60 min prior to addition of the gel. The immersion of the gel in the coating solution may take place for up to 2 days, or up to 4 days.

After the immersion, the gel is supercritically dried utilizing a supercritical fluid, and a metal oxide-coated aerogel is formed. A supercritical fluid is a substance in a supercritical state where distinct gaseous and liquid phases do not exist; that is, the substance is at a temperature and pressure above its critical point, which is defined by a critical temperature (T_{c}) and critical pressure (P_{c}). The supercritical fluid employed in the method may comprise carbon dioxide (CO₂), which has a critical point at a temperature T_{c} of 31.1° C. and a pressure P_{c} of 7.38 MPa. Supercritical drying enables liquid to be removed from the gel without collapse of the aerogel structure. The method may include multiple washes in liquid carbon dioxide to replace ethanol in the pores of the aerogel structure before bringing the carbon dioxide to its supercritical state and evacuating the fluid. Prior to supercritical drying, the gel may be aged in ethanol to remove unreacted metal alkoxide from the coating solution. The aging in ethanol may take place for up to 2 days, or up to 4 days.

In some examples, the gel may be part of a gel composite including the gel and a fibrous material. In such examples, forming the gel includes forming the gel composite by mixing and hydrolyzing gel precursors and impregnating a fibrous material with the gel precursors. Before impregnation with the gel precursors, the fibrous material may be heat treated to remove any binders from surfaces thereof. Upon gelation of the gel precursors, a gel is formed on surfaces and within interstices of the fibrous material. The gel composite is then immersed in the coating solution. An optional aging treatment in ethanol may be carried out after immersion in the coating solution to remove unreacted metal alkoxide as described above. Finally, supercritical drying of the gel leads to formation of an aerogel composite including the metal oxide-coated aerogel and the fibrous material, where the metal-oxide coated aerogel is disposed on surfaces and within interstices of the fibrous material. The metal oxide-coated aerogel of the aerogel composite may have any of the features or characteristics of the thermally stable aerogel described above or elsewhere in this disclosure. Similarly, the fibrous material may have any of the features or characteristics described above or elsewhere in this disclosure.

### Examples

In the present investigation, yttria-stabilized zirconia (YSZ) aerogels from 0 to 30 mol % YO_{1.5} are coated with silica by deposition from a tetraethyl orthosilicate (TEOS) solution. Two routes are combined to improve thermal stability: doping the zirconia lattice with yttria and applying a post-synthetic coating. This work provides insight into inadequately understood foci, including the structure and chemistry of the coating, the phase and structural evolution of silica-coated aerogels beyond 1000° C., and the extent of stability for silica-coating chemistry.

### Experimental Procedures

### Aerogel Synthesis

YSZ aerogels of 0, 10, and 30 mol % YO_{1.5} were prepared using a previously described sol-gel process. Zirconyl chloride octahydrate (ZrOCl₂·8H₂O, Alfa Aesar, 99.9%) and yttrium trichloride hexahydrate (YCl₃·6H₂O, Acros Organics, 99.9%) were first dissolved in 200 proof ethanol (Decon Labs) in separate containers. The standard solids loading was 1.263 mmol metal per mL of ethanol. Deionized (DI) water was added in six times the stoichiometric amount for each metal precursor (e.g., 24 moles water per mole of Zr and 18 moles of water per mole of Y). The precursors were stirred separately for 60 min for hydrolysis. The precursors were then combined and stirred for 15 min. The solution was placed in an ice bath and propylene oxide (PO; CH₃CHCH₂O, Sigma Aldrich) was added dropwise at a ratio of 2.342 mole PO per mole of metal. The solution was stirred for 5 min and then transferred to molds made from polyethylene syringes (24 mL) with the tip cut off. The plunger was placed at 20 mL and the mold was filled to the 10 mL mark. Gelation occurred within 10-30 min. All gels were held in the mold for 24 h.

Gels to remain uncoated were extracted into room temperature 200 proof ethanol and aged for 6 days. Gels to be coated with silica were extracted into a coating solution of TEOS (Si(OC₂H₅)₄, Sigma Aldrich, 98%), DI water, and nitric acid (HNO₃, Sigma Aldrich, 70 wt. %) in 200 proof ethanol and aged for 3 days. The molar ratio of TEOS:ethanol-water:nitric acid was 1:7.7:1.5:0.01 in this example. The coating solutions were stirred for 30 min prior to addition of gels. Following 3 days, the coated gels were extracted into 200 proof ethanol and aged for 3 days to remove unreacted TEOS. All gels were supercritically dried using carbon dioxide. The process used four washes in liquid carbon dioxide to replace ethanol in the pore structure, before bringing the carbon dioxide to its supercritical state and evacuating the fluid.

### Heat Treatments

For all heat treatments at 600° C., 1000° C., and 1200° C., aerogels were placed into high purity alumina crucibles. Heat treatments at 600° C. and extended heat treatments above 1200° C. were performed in a box furnace under air with a temperature ramp of 20° C./min. For 1000° C. and 1200° C., the aerogels were heated in a tube furnace under a flowing argon atmosphere and a ramp of 5° C./min. The maximum temperature for the standard 600° C., 1000° C., and 1200° C. heat treatments was held for 18 min and the aerogels were cooled to room temperature within the furnace.

### Aerogel Characterization

The as-dried (AD) aerogels underwent physical measurement to characterize shrinkage and bulk density. The length and diameter of cylindrical aerogel monoliths were measured and used to calculate bulk density and shrinkage relative to the diameter of the mold. Scanning electron microscopy (SEM) was performed on a Hitachi S4700 or S4800 SEM to characterize pore morphology. Samples were crushed onto carbon tape and imaged uncoated at 2 kV. Energy dispersive spectroscopy (EDS) was performed on a ThermoFisher Axia ChemiSEM. High vacuum mode was used at an accelerating voltage of 30 kV, spot size of 6, and working distance of 10 mm. An area that showed minimal charging was selected and a point analysis (60 s) was run for three points per area. This process was repeated for three areas per sample. The composition was calculated from an average of all point analyses. Samples for (scanning) transmission electron microscopy (S/TEM) were ultrasonicated in ethanol and dispersed on a holey carbon-coated copper grid for TEM analysis. Bright field imaging was performed on a JEOL LaB₆ TEM and STEM EDS was performed using a FEI Talos STEM (ThermoFisher Scientific).

Nitrogen adsorption/desorption experiments were conducted on Micromeritics ASAP 2020 (NASA Glenn Research Center) and Micromeritics 3Flex (University of Illinois at Urbana-Champaign, School of Chemical Sciences, Microanalysis Laboratory) to measure the SSA via the method of Brunauer-Emmett-Teller (BET) and porosity via the method of Barrett-Joyner-Halenda (BJH). Average pore size and [were calculated using the BJH desorption method. Prior to adsorption/desorption, samples were degassed under vacuum and heated at 5° C./min to 80° C. with an 8-h hold.

Powder x-ray diffraction (XRD) was used to identify the crystalline phase and calculate the crystallite size via the Scherrer equation. To prepare samples for XRD, powders were crushed in a mortar and pestle with a small amount of isopropanol. The suspension was dropped via pipette onto a low background holder. XRD was performed on a Bruker D8 Advance (Cu Kα, 1.5406 Å) from 10° to 100° 2θ, 0.02° per step, and 0.25 s per step. Quantitative phase analysis (QPA) was performed using whole pattern fitting (WPF, also known as Rietveld refinement) with pseudo-Voigt fits as implemented in the JADE (Materials Data, Inc.) analysis program with the International Center for Diffraction Data (ICDD) crystallographic database. The following powder diffraction files (PDFs) were used: zirconium oxide, monoclinic (04-004-4339), zirconium oxide, tetragonal (04-005-4207), zirconium oxide, cubic (04-002-8314), and cristobalite (04-007-2134).

### Results

### As-Dried (AD) Aerogel Structure

Table 1 summarizes the physical and textural properties of the AD aerogels following supercritical drying. Comparing the uncoated samples, SSA was highest for 0YSZ and lowest for 10YSZ. Pore volume and average pore size increased with increased yttria content. Both shrinkage and bulk density were reduced with increased yttria content. The effects of SiO₂ coating on the properties of the AD aerogel were generally dependent on the yttria content. For all three compositions, the coating reduced the shrinkage, with the effect most pronounced for 0YSZ. The bulk density was reduced for SiO₂-0YSZ but increased for SiO₂-10YSZ and SiO₂-30YSZ. The coating modestly increased the SSA for 0YSZ and strongly increased the SSA for 30YSZ, with a slight reduction in SSA for 10YSZ. Pore volume and pore size for 0YSZ were nearly doubled upon coating and the increases in pore volume and size were modest for 10YSZ. 30YSZ pore volume and pore size were reduced slightly upon coating. The AD pore size distributions revealed a broadening in the distribution for all materials upon coating. Qualitatively, coated aerogels were much more robust during handling.

TABLE 1
The physical and textural properties of as-dried (AD) aerogels
following supercritical drying. Increased yttria content
coarsens the pore structure. Generally, the effects of
coating are dependent on the yttria content, but shrinkage
is reduced for all materials following coating.

| | SSA | V_{BJH} | D_{BJH} | S | ρ_{b} |
|---|---|---|---|---|---|
| Sample | (m²/g) | (cm³/g) | (nm) | (%) | (g/cm³) |
| 0YSZ | 504 | 1.291 | 7.0 | 29.5 | 0.292 |
| SiO₂-0YSZ | 518 | 2.267 | 13.9 | 15.8 | 0.230 |
| 10YSZ | 455 | 1.793 | 12.3 | 20.7 | 0.198 |
| SiO₂-10YSZ | 448 | 1.892 | 15.9 | 14.1 | 0.227 |
| 30YSZ | 473 | 2.914 | 26.9 | 12.5 | 0.186 |
| SiO₂-30YSZ | 599 | 2.843 | 25.1 | 10.7 | 0.275 |

SSA, Brunauer-Emmett-Teller (BET) specific surface area;
V_{BJH}, Barrett-Joyner-Halenda (BJH) desorption cumulative pore volume;
D_{BJH}, BJH desorption average pore diameter;
S, as-dried shrinkage (diameter);
ρ_{b}, bulk density.

The amount of Si deposited on the aerogel was quantified with EDS for 30YSZ. Attempts to use inductively coupled plasma-optical emission spectroscopy were unsuccessful in quantifying the silicon content accurately. The average atomic ratio of Zr:Y:Si in 30YSZ-SiO₂ was 1.00:0.55:3.01 with no discernable dependence of composition on location. EDS mapping did not reveal any inhomogeneities in the composition of the coated aerogel.

### Aerogel Morphology and Thermal Stability

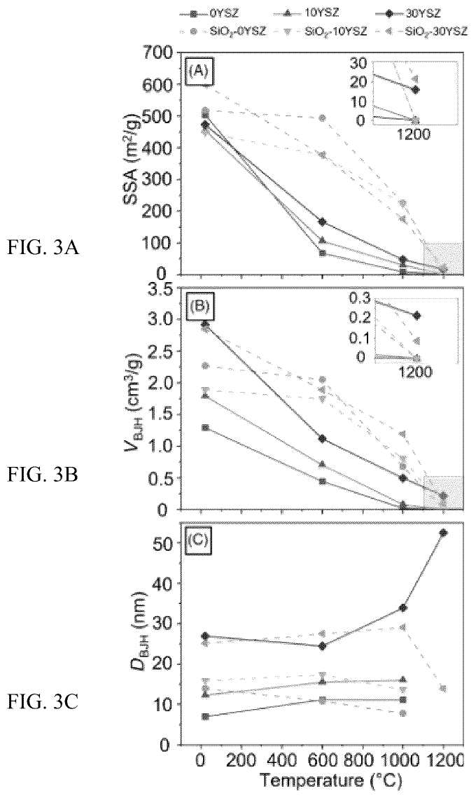

Nitrogen physisorption quantified the specific surface area (SSA), pore volume, and pore size for the AD material and following heat treatments at 600° C., 1000° C., or 1200° C. as shown in FIGS. 3A-3C, respectively. At 600° C., all three coated materials maintained significantly more SSA than their uncoated counterparts, ranging from a factor of 2.3 increase in SSA for 30YSZ and a factor of 7.3 increase for 0YSZ, depicted in FIG. 3A. Among the uncoated materials, increased yttria content led to an increase in SSA at 600° C., 1000° C., and 1200° C. consistent with previous results for YSZ. This trend was not replicated for the coated materials. At 600° C., SiO₂-0YSZ maintained the highest SSA with 494 m²/g. SiO₂-10YSZ and SiO₂-30YSZ were found to have identical SSAs of 378 m²/g. At 1000° C., SiO₂-0YSZ and SiO₂-10YSZ had virtually identical SSAs (226 and 223 m²/g, respectively). At 1200° C., SSA was unmeasurable for coated and uncoated 0YSZ and 10YSZ. Both coated and uncoated 30YSZ samples maintained some SSA to 1200° C., with 16 m²/g for uncoated and 21 m²/g for coated. Similar results were obtained for the pore volume to 1000° C. in FIG. 3B, where coated materials maintained greater pore volume than all uncoated materials.

Again, increased yttria content increased pore volume at all temperatures for uncoated materials. At 1000° C., SiO₂-30YSZ maintains the greatest pore volume with 1.190 cm³/g. At 1200° C., pore volume was unmeasurable for coated and uncoated 0YSZ and 10YSZ. Uncoated 30YSZ had the highest pore volume at 1200° C. with 0.213 cm³/g. As shown in FIG. 3C, pore size increased with increased yttria content as described previously. To 1000° C., pore size remained relatively constant for all materials with no clear impact from coating. From 1000° C. to 1200° C., the pore size increased from 33.9 to 52.5 nm for uncoated 30YSZ and decreased from 29.1 to 13.9 nm for SiO₂-30YSZ. Pore size could not be analyzed for coated and uncoated 0YSZ and 10YSZ heat treated to 1200° C. on account of no measurable surface area or mesoporosity.

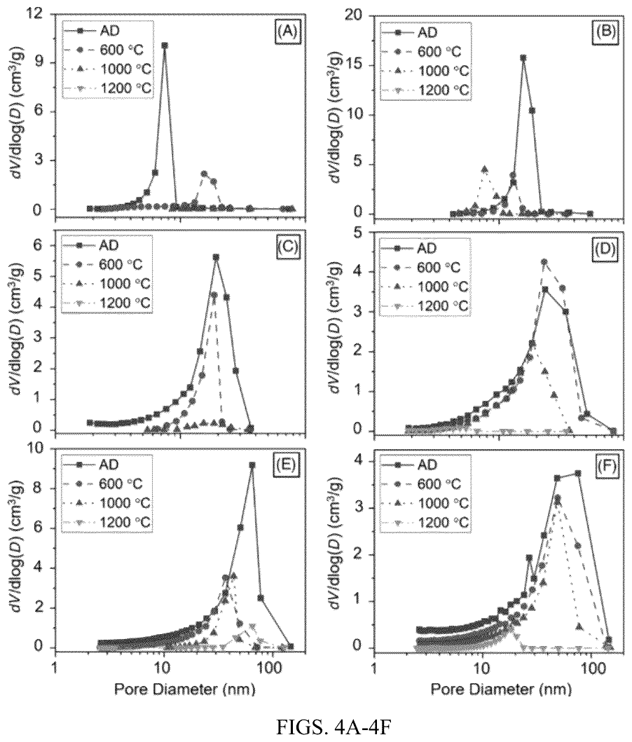

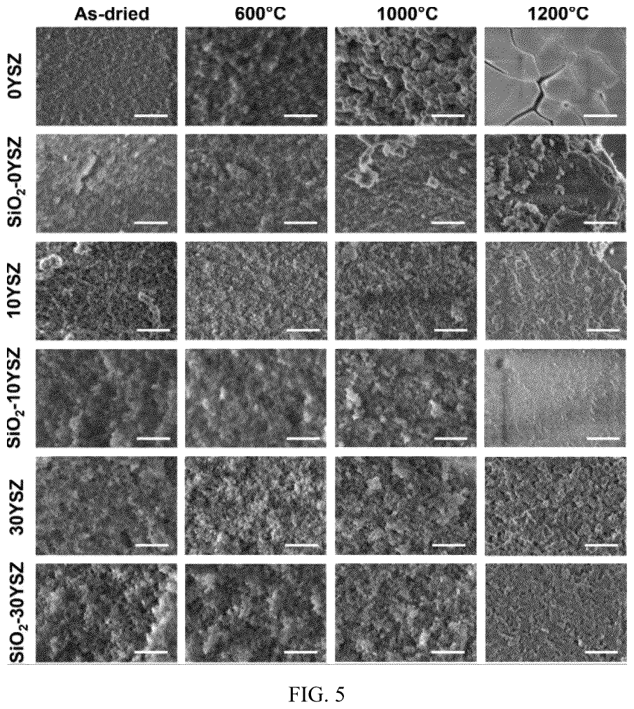

The BJH desorption pore size distributions are included in FIGS. 4A-4F, respectively, for 0YSZ (4A), SiO₂-0YSZ (4B), 10YSZ (4C), SiO₂-10YSZ (4D), 30YSZ (4E), and SiO₂-30YSZ (4F). From AD to 600° C., the pore size distribution changes significantly for all materials with the exception of uncoated 10YSZ, SiO₂-10YSZ, and SiO₂-30YSZ. By 1000° C., the pore size distribution is essentially flat for uncoated 0YSZ and hardly detectable for uncoated 10YSZ. For the coated materials from 600° C. to 1000° C., the distribution shifts to smaller average pore size for SiO₂-0YSZ and SiO₂-10YSZ, though the effect is most pronounced for SiO₂-0YSZ. The distribution for SiO₂-30YSZ is remarkably stable from AD to 1000° C., with only a slight reduction in volume from larger pores. At 1200° C., coated and uncoated 0YSZ and 10YSZ have no measurable pore size distributions as described above. For 30YSZ, the change in distribution for the coated material is drastic, with only a minor amount of smaller pores, most less than 20 nm, remaining in the material. The uncoated 30YSZ also loses much of its pore volume at 1200° C., but without the significant shift in the average pore size.

SEM micrographs of the aerogels are displayed in FIG. 5. From AD to 1000° C., there were no discernable differences at the resolution available with SEM between the coated and uncoated samples, with the notable exception of 0YSZ at 1000° C. For uncoated 0YSZ at 1000° C., spherical particles with some apparent necking between particles were observed. Distinct particles were no longer evident for uncoated 0YSZ at 1200° C., and the sample morphology resembled fully densified material with grains around ˜1 μm in size. No comparable particles or grains were observed in SiO₂-0YSZ at 1000° C. or 1200° C.

At 1200° C., 10YSZ and 30YSZ, both coated and uncoated, showed distinct evolution in morphology. 10YSZ and 30YSZ showed significant particle growth and necking between particles. The sponge-like mesoporous network was no longer visible, replaced by large macropores between partially sintered particles. The changes in morphology of SiO₂-10YSZ and SiO₂-30YSZ were even more dramatic. Not only did it appear as if particles had grown but also sintered together to a greater extent than in the uncoated samples. The macropore size in the coated samples is clearly smaller than that in the uncoated samples. This result harkens to the change in average mesopore size from 1000° C. to 1200° C. shown in FIG. 3C, where 30YSZ increased and SiO₂-30YSZ decreased in average pore size.

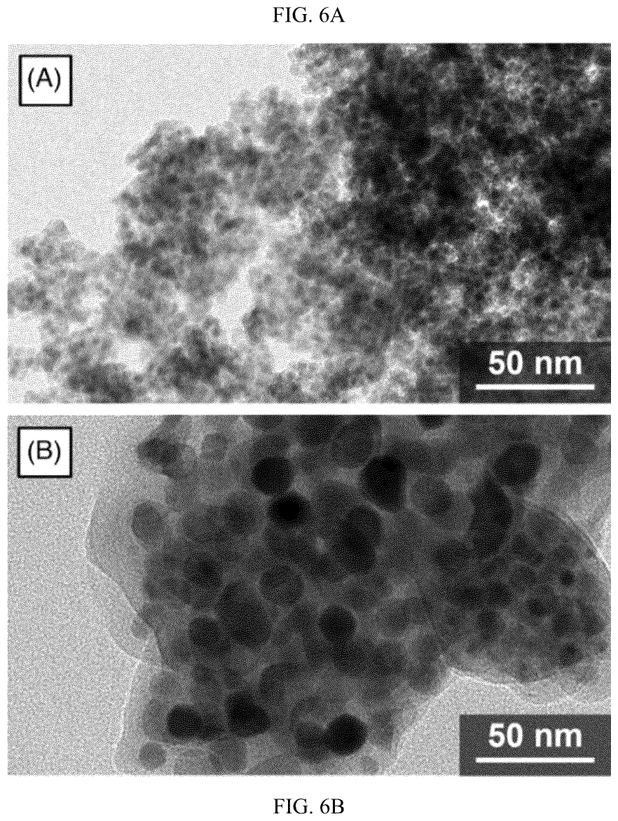

Given the limits of resolution with SEM, TEM was also performed on SiO₂-30YSZ heat treated at 1000° C. and 1200° C. and the images are shown in FIGS. 6A and 6B, respectively. At 1000° C., the small particle size and mesoporosity were visible. The morphology changed significantly after heat treatment at 1200° C. The particle size was significantly larger than at 1000° C. Furthermore, mesoporosity was no longer visible. The sample took on the appearance of well-defined spherical particles embedded in a continuous matrix. From the TEM images, the line-intercept method was employed to estimate particle size. At 1000° C., the estimated particle size was 5.2 (±0.7) nm. At 1200° C., the estimated particle size was 16.0 (±1.7) nm.

### Crystal Structure Evolution

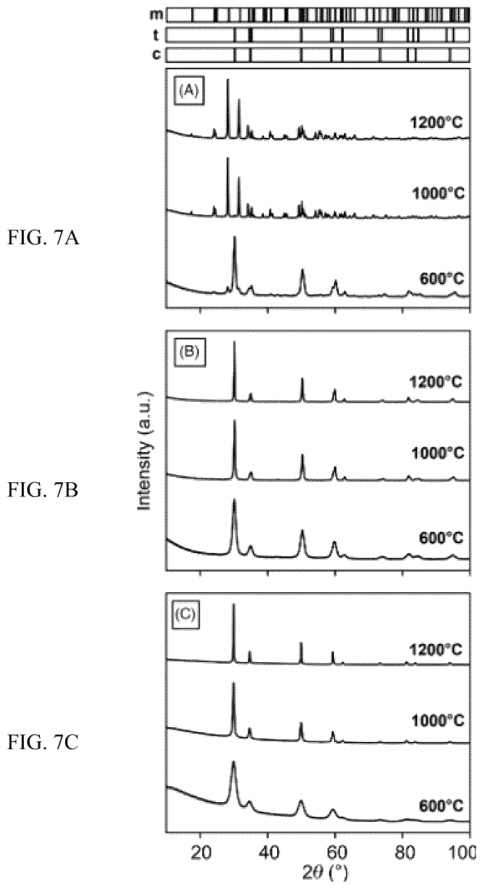

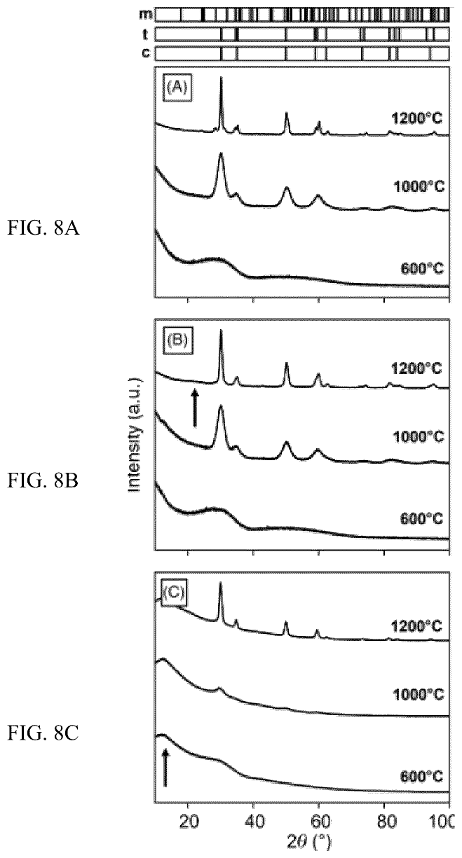

All aerogel samples were X-ray amorphous after supercritical drying. The XRD data for the heat-treated uncoated 0YSZ, 10YSZ, and 30YSZ samples are displayed in FIGS. 7A-7C. The XRD data for all coated aerogel samples are displayed in FIGS. 8A-8C. In uncoated 0YSZ (FIG. 7A), heat treatment at 600° C. resulted in crystallization of the aerogel to a mixture of monoclinic ZrO₂, along with a tetragonal ZrO₂ phase that is presumably restricted from full transformation to the monoclinic phase due to the fine crystallite size at this point. With an increase in heat treatment temperature to 1000° C. and 1200° C., monoclinic ZrO₂ became the dominant phase observed in the XRD data. At 1000° C., a small peak around ˜30° 2θ was attributed to the minor presence of tetragonal ZrO₂, although this phase was no longer observable at 1200° C.

With increasing temperature, the peak shapes qualitatively tended to decrease in width and increase in intensity. Such a trend could be indicative of increasing crystallite size and/or crystalline content. In the SiO₂-0YSZ samples (FIG. 8A), no distinct crystallization was observed in the samples heat treated at 600° C. Heat treatment at 1000° C. resulted in the formation of very wide but distinct tetragonal/cubic phase peaks. These peaks narrow after heat treatment at 1200° C., similar to uncoated 0YSZ in FIG. 7A. While the monoclinic phase was the dominant phase at 1200° C. in uncoated 0YSZ, monoclinic ZrO₂ was only observed as a minor phase in SiO₂-0YSZ at 1200° C. (FIG. 8A).

Regardless of the heat treatment temperature, 10YSZ samples did not present any evidence of phase transformation to a monoclinic phase upon crystallization and cooling. Given the fine crystallite size, a more robust distinction between potentially present cubic or tetragonal phases was not possible. In uncoated 10YSZ (FIG. 7B), heat treatment at 600° C. resulted in crystallization of the aerogel, similar to uncoated 0YSZ. With increasing temperature, these peaks became narrower and increased in magnitude. XRD analysis of SiO₂-10YSZ (FIG. 8B) showed little to no evidence of crystallization at 600° C., correlating well with the results obtained on SiO₂-0YSZ. Up to 1200° C., the peak widths of the coated samples were consistently wider than the uncoated samples for 10YSZ. In SiO₂-10YSZ, there was also a small amorphous hump (highlighted by black arrow in the figure) present at low angles, being most distinct at 1200° C.

The 30YSZ sample exhibited crystallization to the cubic phase at 600° C. (FIG. 7C), which persisted in additional heat treatments at both 1000° C. and 1200° C. Though the tetragonal phase cannot be ruled out from the XRD patterns, consideration of the yttria doping level and the pattern together supports formation of the cubic phase. No evidence of crystallization of SiO₂-30YSZ was observed at 600° C. The formation of very minor peaks was observed after heat treatment of SiO₂-30YSZ at 1000° C., although the sample appeared to remain largely amorphous. At 1200° C., distinct cubic peaks were formed in SiO₂-30YSZ.

A similar amorphous hump (highlighted by black arrows) with slighter greater magnitude was also observed in SiO₂-30YSZ (FIG. 8C) and was consistently observed from 600° C. to 1200° C. This amorphous hump was not observed in uncoated 30YSZ, suggesting that the SiO₂ coating may be contributing to the formation of a separate amorphous phase after heat treatment. This is consistent with the TEM observations presented in FIG. 6B.

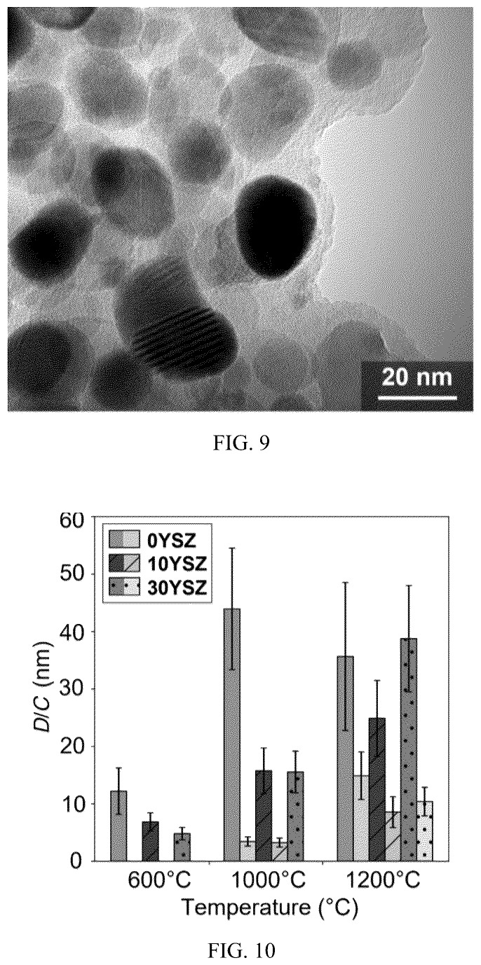

More thorough interrogation of the crystallinity, morphology, and chemical distribution in the SiO₂-30YSZ sample was carried out via STEM. Bright field micrographs (FIG. 9) showed globular, crystalline particles interspersed in an apparently noncrystalline phase, per the absence of any discernable lattice fringes. EDS compositional analysis carried out in dark field indicated that the bright globular particles were rich in both Zr and Y, while the surrounding areas were rich in Si, confirming that the SiO₂ coating was, at least partially, segregated into a distinct and separate phase from 30YSZ after this heat treatment.

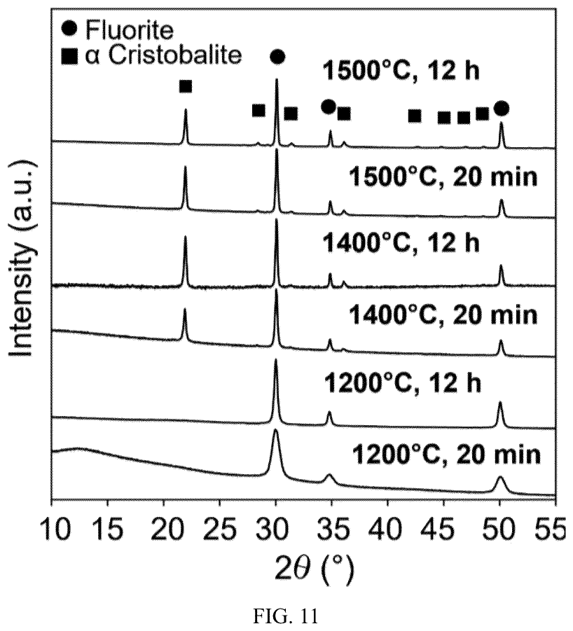

Given the observed difference in crystallization behavior, the emergence of a potentially amorphous secondary matrix phase and qualitative peak sharpening trends, a more comprehensive analysis of crystallite size evolution was merited beyond what was possible to observe via S/TEM on the SiO₂-30YSZ specimens. A modified Scherrer analysis (FIG. 10) was performed on the Gaussian fitted peak shapes as a route to document relative changes in crystallite size between compositions and coating conditions. The modification involved dividing the crystallite size, D, by the dimensionless shape factor, C, to allow for relative comparison of crystallite sizes among samples. The absolute crystallite size is more directly extracted from the TEM observations that have already been presented, but this level of analysis was not possible for all specimens. Little to no crystallization of any of the coated samples was observed at 600° C., so crystallite size could not be quantified at this temperature. In both the undoped and the 10YSZ samples, it was apparent that the coated samples consisted of crystallites at least an order of magnitude smaller in size than the uncoated samples at 1000° C., while little to no crystallization had begun at 1000° C. for the SiO₂-30YSZ sample. There was not a large difference in crystallite size between the 10YSZ and 30YSZ samples at 1000° C. It appeared that at this temperature, the SiO₂ coating exhibited a greater influence on the size of the crystallites than the dopant concentration. At 1200° C., the crystallite size of SiO₂-10YSZ and SiO₂-30YSZ was comparable, and just smaller than SiO₂-0YSZ.

The confluence of XRD and S/TEM data presented thus far suggests the eventual segregation of a distinct, amorphous Si-rich phase. Additional heat treatments were therefore carried out to assess the bounds of this behavior for the SiO₂-30YSZ aerogels. The XRD data collected following these heat treatments are plotted in FIG. 11. The original SiO₂-30YSZ sample heat treated at 1200° C. is included in the figure for comparison. As previously stated, there was a large amorphous hump present in this sample at low angles after the initial heat treatment at 1200° C. This amorphous signal decreased in intensity upon further heat treatment at 1200° C. for 12 h, and no additional phases were observed. Heat treatment at 1400° C. for 12 h resulted in the crystallization of α-cristobalite, a low temperature tetragonal polymorph of SiO₂.

The crystallization of cristobalite was also observed at 1500° C. after 20 min and at 1500° C. after 12 h. The reduction in magnitude of the amorphous hump after 12 h at 1200° C. (and the subsequent crystallization of SiO₂ at higher temperatures) suggested that the onset of devitrification may have been possible at this temperature but remained undetectable via XRD.

### DISCUSSION

Given the excellent stability of silica-coated YSZ aerogels presented above, it is valuable to consider possible mechanisms responsible for the initial changes in the AD structure, the unique evolution of the coated aerogels and the eventual thermal stability or lack thereof above a critical temperature. The following discussion will address each of these points in greater depth.

Changes to the as-Dried Structure Upon Coating

The effect of yttria content on the AD structure has been established previously. Increased yttria content forms a coarser structure, with lower SSA and larger pore size. These trends were observed in this work, with the pore size increasing from 0 to 30 mol % YO_{1.5} for both coated and uncoated aerogels. These changes to the AD structure have been previously attributed to a change in the average precursor oxidation state.

The effects of coating on the structure can be inferred from the physical measurements of the aerogel, including shrinkage and density, and the measurements of the mesoporous structure with nitrogen physisorption. For all compositions, addition of the coating reduced the shrinkage. The reduction in shrinkage is likely a result of increased robustness of the gel toward the pressures that drive shrinkage during gelation and drying. The difference in shrinkage between coated and uncoated was reduced with increased yttria content. This change could simply be related to the propensity of the uncoated gel to shrink, perhaps related to a weaker gel structure. With a stronger gel, the amount of shrinkage is reduced and the effect of coating on reducing shrinkage is not as evident.

The change in density is likely a convolution of change in shrinkage and material deposition from the coating process. For a fixed shrinkage, and therefore gel size, coating will deposit material on the gel and lead to an increase in density. A reduction in shrinkage, all other factors equal, would typically reduce the density of an aerogel since a given mass of solution-phase precursors occupies a greater volume in the gel form. For 0YSZ, the shrinkage is dramatically reduced from 29.5% to 15.8%. The reduction in shrinkage appears to outweigh the effect of material deposition, and the bulk density for this material decreased. For 10 and 30YSZ, the change in shrinkage was smaller, and the deposition of material led to an increase in bulk density. Though an increase in density is not necessarily ideal for the purposes of lightweight insulation, the potential for an improvement in thermal stability at temperatures of interest may well be worth the cost.

When interpreting the results of nitrogen physisorption, it is essential to keep in mind the limitations of the technique. Adsorption can occur on any free surface that is accessible to nitrogen molecules so calculation of SSA includes both mesoporosity (2-100 nm) and macroporosity (>100 nm). The BJH method for calculating cumulative pore volume, average pore size, and pore size distribution relies on the phenomenon of capillary condensation, which occurs over the mesopore range (2-100 nm) and up to 150 nm. Therefore, the cumulative pore volume and average pore size only represent mesopores and not macropores. With this limitation of nitrogen physisorption in mind, for 30YSZ, the slight reduction in mesopore volume and size likely reflects the filling of some mesoporosity with reacted TEOS. Since the change in mesopore volume and size is small in relation to the change in SSA, the significant increase of SSA is likely the result of increased macroporosity, which itself stems from reduced macroscopic shrinkage of the aerogel. Though the measured pore size distributions cannot directly measure macroporosity larger than 150 nm, a possible change in macroporosity can still be gleaned when comparing the AD distributions in FIG. 4E for 30YSZ and FIG. 4F for SiO₂-30YSZ. The distribution for xYSZ-SiO₂ indicates greater pore volume contributions from pores of 100-150 nm compared to xYSZ for x=0, 10, and 30. This shift, along with the reduction in macroscopic shrinkage and small change in mesopore volume, suggests that increased macroporosity is the source of increased SSA in SiO₂-30YSZ. The modest increase in pore volume and pore size in 0YSZ and 10YSZ may be the result of the greater reduction in shrinkage for these materials.

### SiO₂ Coating Evolution

The addition of a SiO₂ coating appeared to suppress and/or delay crystallization and densification of the aerogels up to 1000° C. In the coated samples, there was also an amorphous hump present at low angles (more apparent in the coated 30YSZ samples (FIG. 8C)), and no SiO₂-containing crystalline phases (such as crystalline SiO₂, zircon [ZrSiO₄], or yttrialite/yttrium disilicate [Y₂Si₂O₇]) were observed. These results indicated that SiO₂ may be present as an amorphous coating on the ZrO₂ aerogel up to 1200° C., exhibiting limited reactivity with the aerogel itself. According to thermodynamic assessment of the ZrO₂—SiO₂ binary system, SiO₂ has no solid solubility in any polymorph of ZrO₂ and vice versa. Additionally, ZrSiO₄ should be present in mixtures of ZrO₂ and SiO₂ up to ˜1700° C. However, the current results suggest that the amorphous SiO₂ coating is not reacting with ZrO₂ or Y₂O₃ to form any extraneous phases, and the SiO₂ itself is not crystallizing at temperatures up to 1200° C. despite thermodynamic prediction from binary studies of the ZrO₂—SiO₂ system. It is important to note that SiO₂ was added as a coating only after the precursors for 30YSZ were mixed and a gel was formed. The separate addition of SiO₂ to the coated gels could have contributed to the lack of reaction with 30YSZ to form SiO₂-containing phases, given that it was not directly mixed into the gel with ZrO₂ and Y₂O₃ precursors. Additionally, no stable ternary compound exists in the ZrO₂—Y₂O₃—SiO₂ system, although an invariant reaction of c-Zr_{0.8}Y_{0.2}O_{1.9}+SiO₂→0.8ZrSiO₄+0.1Y₂Si₂O₇ was reported to occur when the system was assessed at 1400° C. and 1600° C.

The devitrification of SiO₂ has been shown to be driven by nucleation (rearrangement of atoms) and diffusion (crystallite growth). Higher temperatures tend to decrease the incubation period for nucleation, leading to faster crystallization. For pure fused SiO₂, the onset of devitrification typically occurs at minimum ˜1300° C., although the presence of impurities or network modifiers (e.g., borosilicate glasses) can decrease this temperature as well as increase the kinetics of crystallization. At 1200° C., 12 h, nucleation of cristobalite possibly occurred in SiO₂-30YSZ (which may explain the decrease in magnitude of the amorphous hump, as shown in FIG. 11), but the temperature was too low to drive diffusion of nuclei to promote crystallite growth. Additionally, because SiO₂ was not directly mixed with ZrO₂ or Y₂O₃ precursors, the limited presence of network modifiers in the amorphous SiO₂ phase is consistent with the observed retardation of crystallization.

### Thermal Stability of Coated Aerogels

Coated aerogels displayed significantly higher thermal stability at 600° C. and 1000° C., exhibiting far less dramatic reductions in SSA and V_{BJH} when compared to uncoated aerogels after the same heat treatments. Taking 30YSZ as an example, the improvement upon coating at 600° C. was 2.3 times the SSA and 1.7 times the V_{BJH} relative to the uncoated 30YSZ. This improvement in performance with coating grew at 1000° C., at which point SiO₂-30YSZ maintained 3.7 times the SSA and 2.4 times the V_{BJH} of 30YSZ. This divergence in performance is visually indicated in FIGS. 3A and 3B. As shown previously, increasing the concentration of YO_{1.5} in a ZrO₂ aerogel increased the SSA at 1000° C. by a factor of 4.8, relative to an undoped ZrO₂ aerogel. This improvement was built upon by coating 30YSZ with SiO₂, wherein the SSA at 1000° C. increased by a further factor of 3.7 relative to 30YSZ.

This improvement in thermal stability is meaningful in the context of applications that require highly insulative mesoporous materials exposed to temperatures up to 1000° C. To expand the impact of this improvement, a deeper understanding of the source of thermal stability for coated aerogels will prove useful in developing refined coating approaches that enhance thermal stability to an even greater degree than achieved here. To this end, several sources and mechanisms of improved thermal stability may be evaluated. Several mechanisms have already been posited and these will be reviewed in the context of another potentially critical driving force, specific surface energy, that is highlighted by the data presented here.

Previous work touts the effect of surface SiO₂ particles to pin grain and particle boundaries, inhibiting both densification and crystallite and/or grain growth. Formation of secondary phases and/or particles at interfaces has repeatedly been demonstrated to induce solute drag and inhibit particle, grain, and crystallite growth. The inhibition of growth is generally achieved with small amounts of the secondary phase, often less than 10 mol %, and may be the result of space charge effect, reduction in surface energy with an increase in the surface excess of the dopant, or a shift in the relative values of surface and grain boundary energies. On the other hand, SiO₂ has also been employed as a sintering aid for ceramics, especially in cases where the concentration of SiO₂ is high, allowing the SiO₂ to form a continuous film and enable liquid phase sintering. The pitfall of viscous sintering, which is particularly relevant given the high concentration of Si measured in the coated YSZ aerogels, will be further discussed in the next section. Given the 3:1 ratio of Si to Zr measured in the coated aerogel, referring to the SiO₂ phase as a secondary phase or pinning phase may not be accurate. The present work also suggests that some combination of these opposing effects (suppressed grain growth vs. enhanced sintering) may coexist in the present specimens. Notably, coating with silica pushes the onset of crystallization in the aerogels to much higher temperatures than uncoated specimens. But once these crystallites are formed, the presence of silica not only continued to suppress crystallite growth from 1000° C. to 1200° C., but also contributed to significant densification over this same temperature range.

Beyond solute drag and viscous sintering, particle size has been suggested to also play a role in aerogel densification behavior. As defined, crystallite size refers to the size of coherent diffraction domains in XRD whereas particle size refers to the size of coherent aggregates as identified via microscopy. Therefore, a particle may consist of two or more crystallites, though given the small particle size of the presently studied materials, crystallite size and particle size are likely equivalent.

It is believed that the increased size of both the particles that make up the aerogel backbone and the necks between particles also improve the robustness of the structure toward densification. This hypothesis is also supported by the fact that maximum capillary pressure is inversely related to particle size, and with reduced capillary pressure comes reduced driving force for densification and compaction upon heating. Molecular dynamics simulations of silica aerogel sintering also support this relationship between increasing primary particle size and reduced densification rates.

Reduced surface energy is hypothesized to be an important factor in improving the thermal stability of highly porous, high SSA materials such as aerogels. Considering the large amount of Si detected in the coated material, it can be assumed that 30YSZ-SiO₂ has a surface composed primary of SiO₂. The surface energy of amorphous silica is 0.259 J/m² if dry and 0.129 J/m² if fully hydrated. This can be compared to that of 30 mol % YO_{1.5}—ZrO₂ (30YSZ), which is 0.83 J/m² if dry as averaged for a polycrystalline sample, with little dependence on whether the YSZ is crystalline or amorphous. The aerogels are hydrophilic and likely have some degree of hydration on their surface, though the water adsorbed to the surface should be negligible at temperatures where sintering and densification occur. Therefore, it is sensible to compare the dry surface energies. Comparing these two values, the surface energy of amorphous SiO₂ (0.259 J/m²) is significantly lower than that of 30YSZ (0.83 J/m²). This will reduce the driving force for sintering, densification, and elimination of the surface area and associated surface energy.

As an example, one can consider the change in energy associated with surface area for a surface composed of SiO₂ compared to that of a surface composed of 30YSZ. Assuming an SSA of 400 m²/g, the energy arising from the surface for SiO₂ is 104 J/g and for 30YSZ is 332 J/g-over a factor of three reduction in energy for SiO₂. In the context of a key thermodynamic driving force for sintering and densification, this reduction may prove significant. There is no evidence generated by this work to explicitly refute the previously presented hypotheses on the effect of pinning and increased particle size. Rather, the hypothesis on reduced surface energy is presented as an additional possible mechanism by which the process of coating or capping an aerogel improves stability of the pore structure at high temperatures. Further work characterizing the starting structure of the material, namely, on how the coating solution changes the YSZ aerogel's structure and chemistry, and the evolution of the SiO₂ in relation to the YSZ aerogel from the range of room temperature to 1000° C., may be beneficial to better understand the source of thermal stability in coated metal oxide aerogels.

Enhanced Densification Beyond 1000° C. with SiO₂ Coatings

Despite a significant improvement in thermal stability with SiO₂ coating to 1000° C., the SiO₂ coating enhances densification beyond this temperature. The slope of SSA and V_{BJH} in FIGS. 3A and 3B for coated aerogels indicates a sharp decrease in the thermal stability above 1000° C. The SSA for 30YSZ and SiO₂-30YSZ is virtually identical and the mesopore volume of 30YSZ-SiO₂ is 2.3 times smaller than 30YSZ, a stark change from 1000° C., where 30YSZ-SiO₂ maintains 2.4 times the mesopore volume of 30YSZ. Despite the massive loss of SSA and V_{BJH}, the crystallite sizes of coated aerogels remain smaller than their uncoated counterparts.

Comparing the thermal stability of coated aerogels to previously studied capped and coated aerogels to temperatures of 1200° C. is not possible, as Wu only measured stability to 600° C. and Zu measured stability only to 1000° C. for ZrO₂ and TiO₂ aerogels. It is important to note the work by Zu demonstrated that coated Al₂O₃ aerogels maintained good thermal stability to 1300° C. with an SSA of 139 m²/g. The fact that ZrO₂ and TiO₂ aerogels were reported to only 1000° C. suggests these materials also densified beyond this temperature.

The TEM images of SiO₂-30YSZ at 1200° C. in FIGS. 6A and 6B respectively, show a dramatic change in morphology at multiple length scales. The structure goes from a porous, web-like structure to one that appears fully dense with clearly defined spherical particles contained within a nebulous matrix. The dense appearance of the aerogel in both SEM and TEM collected after 1200° C. heat treatments implies that SiO₂ may be flowing and enabling viscous sintering of the aerogel. Previous work has demonstrated that viscous sintering is an effective means of enhancing densification and is expected to be enabled at temperatures above 1100° C. for amorphous SiO₂. Small particle size is expected to lower the temperature at which viscous sintering can occur in SiO₂, often from 50% to 100% of the bulk melting point of 1710° C. Structural rearrangements are also expected up to and at the glass transition temperature of 1207° C. for bulk amorphous SiO₂ that would aid in the rearrangement and densification of the aerogel structure. It is hypothesized that viscous sintering, enabled by the presence of over 60 wt. % SiO₂ in SiO₂-30YSZ, enhances densification, reducing the thermal stability of this material at temperatures exceeding 1000° C.

As SiO₂ flows, it may be filling in mesopores and aiding in the rearrangement and compaction of primary particles, leading to the dramatic reduction in mesopore volume and average mesopore size observed from 1000° C. to 1200° C. in FIGS. 3B and 3C. At 1200° C., there is no sign of mesoporosity in the TEM image shown in FIG. 6B, which instead reveals the formation of extremely spherical YSZ particles embedded in an amorphous SiO₂ matrix. The chemical compositions of these two unique areas are supported by TEM EDS data included in FIG. 9C. This effect has been reported previously for nanocrystalline YSZ polycrystals coated with a sodium strontium silicate glass. Sintering at 1400° C. for 1 h led to highly faceted polyhedral grains for uncoated YSZ and increasingly round grains for YSZ with increasing glass content. This effect was posited by the authors to be the result of the SiO₂ coating exerting a homogenous strain across the surface of the YSZ grains but may also result from a change in the relative surface energy of crystalline facets in YSZ. The suppression of crystallite growth of YSZ with SiO₂ coatings has also been previously noted and is attributed to the SiO₂ layers serving as grain boundary pinning agents and diffusion barriers, effectively limiting the ability of adjacent YSZ particles to diffuse together.

Overall, the ability of SiO₂ to flow at temperatures exceeding 1000° C. enabled viscous sintering of the aerogel. This leads to rapid densification and destabilization of the mesoporous structure from 1000° C. to 1200° C. SiO₂-coated aerogels did not offer any improvement in thermal stability at 1200° C. and will be limited to use to temperatures up to 1000° C. Despite enhancing densification of the pore structure, the SiO₂ coating continued to serve as a diffusion barrier, preventing the growth of crystallites to 1200° C. though this is not enough to prevent destabilization of the mesoporous structure.

### SUMMARY

SiO₂-coated YSZ aerogels were investigated at temperatures up to 1200° C. to determine pore structure stability for thermal management applications. Significant improvements in retaining the mesoporous structure of the aerogels were observed by the use of the SiO₂ coating up to 1000° C. The structural stability provided by the coating was largely attributed to grain boundary pinning to reduce crystallite and particle growth, in addition to reduction in surface energy, which reduces the driving force for densification. However, the amorphous SiO₂ coating can be detrimental to pore structure stability at 1200° C. due to viscous sintering. Thus, the capping/surface modification approach was moderately successful in retaining mesoporous structure of aerogels up to 1000° C. Other coating chemistries may be considered that do not remain viscous or flow at temperatures of interest.

To clarify the use of and to hereby provide notice to the public, the phrases “at least one of <A>, <B>, . . . and <N>” or “at least one of <A>, <B>, . . . <N>, or combinations thereof” or “<A>, <B>, . . . and/or <N>” are defined by the Applicant in the broadest sense, superseding any other implied definitions hereinbefore or hereinafter unless expressly asserted by the Applicant to the contrary, to mean one or more elements selected from the group comprising A, B, . . . and N. In other words, the phrases mean any combination of one or more of the elements A, B, . . . or N including any one element alone or the one element in combination with one or more of the other elements which may also include, in combination, additional elements not listed. Unless otherwise indicated or the context suggests otherwise, as used herein, “a” or “an” means “at least one” or “one or more.”

While various embodiments have been described, it will be apparent to those of ordinary skill in the art that many more embodiments and implementations are possible. Accordingly, the embodiments described herein are examples, not the only possible embodiments and implementations.

1. A thermally stable aerogel comprising:
an aerogel structure comprising yttria-stabilized zirconia (YSZ) including at least about 20 mol. % yttria (YO_{1.5}) in zirconia (ZrO₂);
a coating on the aerogel structure, the coating comprising a metal oxide selected from the group consisting of silica, alumina, zirconia, and titania.

2. The thermally stable aerogel of claim 1, wherein the YSZ includes from 30 mol. % yttria (YO_{1.5}) to 50 mol. % yttria (YO_{1.5}) in the zirconia.

3. The thermally stable aerogel of claim 1 having a specific surface area (SSA) of at least 350 m²/g at 600° C.

4. The thermally stable aerogel of claim 1 having a cumulative pore volume of at least about 1.8 cm³/g at 600° C.

5. The thermally stable aerogel of claim 1, wherein the YSZ remains amorphous up to 1000° C. as determined by x-ray diffraction.

6. The thermally stable aerogel of claim 1, wherein the coating has a thickness less than an average size of pores of the aerogel structure.

7. The thermally stable aerogel of claim 1, wherein the aerogel structure includes pores from 20 nm to 50 nm in average size.

8. The thermally stable aerogel of claim 1, wherein the coating has a thickness in a range from 1 nm to 10 nm.

9. An insulation product including the thermally stable aerogel of claim 1.

10. An aerogel composite comprising:
a fibrous material;
an aerogel on surfaces and within interstices of the fibrous material, the aerogel including an aerogel structure comprising yttria-stabilized zirconia (YSZ); and
a coating on the aerogel structure, the coating comprising a metal oxide.

11. The aerogel composite of claim 10, wherein the fibrous material comprises a woven fibrous material.

12. The aerogel composite of claim 10, wherein the fibrous material comprises a non-woven fibrous material.

13. The aerogel composite of claim 10, wherein the fibrous material comprises natural or synthetic fibers selected from the group consisting of alumina fibers, aluminosilicate fibers, and aluminoborosilicate fibers.

14. The aerogel composite of claim 10, wherein the metal oxide is selected from the group consisting of silica, alumina, zirconia, and titania.

15. The aerogel composite of claim 10, wherein the YSZ includes from 20 mol. % yttria (YO_{1.5}) to 50 mol. % yttria (YO_{1.5}) in zirconia (ZrO₂).

16. The aerogel composite of claim 10 having a configuration of a flexible sheet.

17. An insulation product comprising the aerogel composite of claim 10.

18. A method of forming a thermally stable aerogel, the method comprising:
forming a gel comprising yttria-stabilized zirconia (YSZ) including at least about 20 mol. % yttria (YO_{1.5}) in zirconia (ZrO₂);
immersing the gel in a coating solution comprising a metal alkoxide and ethanol; and
after the immersion, supercritically drying the gel, thereby forming a metal oxide-coated aerogel.

19. The method of claim 18, wherein the coating solution includes the metal alkoxide at a concentration in a range from 20 vol. % to 30 vol. %.

20. The method of claim 18, wherein the metal alkoxide is selected from the group consisting of tetraethyl orthosilicate, aluminum-tri-sec-butoxide, zirconium(IV) butoxide, and titanium(IV) isopropoxide.
